(19) United States
(12) Patent Application Publication
(10) Pub. No.: US 2016/0313147 A1
(43) Pub. Date: Oct. 27, 2016

(54) SYSTEMS AND DEVICES FOR PROGRAMMING AND TESTING AUDIO MESSAGING DEVICES

(71) Applicant: The Skylife Company, Inc., Rossford, OH (US)

(72) Inventors: Jeffrey J. Potter, Toledo, OH (US); Rory McDonnel, Toledo, OH (US); James Ressler, Sylvania, OH (US); Anthony Kujawa, Waterville, OH (US); Andrew Potter, Sylvania, OH (US); Iain McNeil, Sylvania, OH (US); Steven Busby, Toledo, OH (US); Matthew Medlin, Sylvania, OH (US); Anais Marrero, US, OH (US); Michael Kennedy, Plano, TX (US); Terry C. Potter, Lambertville, MI (US)

(21) Appl. No.: 15/133,720

(22) Filed: Apr. 20, 2016

Related U.S. Application Data
(60) Provisional application No. 62/152,219, filed on Apr. 24, 2015.

(51) Int. Cl. G01D 7/00; G01D 18/00

(52) U.S. Cl. CPC G01D 7/00; G01D 18/00

(57) ABSTRACT

Systems and methods of audio card programming and testing are disclosed. The programming and testing device comprises a housing, a data storage device contained within the housing, a radio transmission device contained within the housing and adapted to receive data from the data storage device, and an audio transmission device contained within the housing and adapted to receive data from the data storage device.

### REFERENCE TO RELATED APPLICATION

This application claims priority to U.S. Provisional Application No. 62/152,219 entitled “SYSTEMS AND DEVICES FOR PROGRAMMING AND TESTING AUDIO MESSAGING DEVICES” filed Apr. 24, 2015, which is entirely incorporated by reference.

### BACKGROUND

1. Field of the Invention

The present invention relates to systems and devices for programming and testing audio messaging devices. More particularly, the invention is directed to systems and devices for programming and testing audio messaging devices for delivery to remote locations.

2. Description of the Background

Numerous circumstances require the transport and delivery of various kinds of cargo to inaccessible or remote areas where ground transportation is not possible or timely. For example, in the event that people are trapped or disabled in a remote area, a hostile environment, or an area ravaged by a natural disaster, it may become necessary or desirable to supply them with food, water, medicine, shelter, and other supplies as rapidly as possible. Similarly, in times of warfare, battlefields may be in remote locations or hostile environments. Likewise, it may be necessary to deliver supplies such as fuel to stranded people. Of course, in times of war or other hostilities, it may be essential to provide support to permit the stranded personnel to evacuate the position in which they find themselves.

Many remote locations or hostile environments may be in areas such as deserts or large expanses of otherwise uninhabited or inhospitable terrain. Because of the remoteness of a location or its inaccessibility, supplies are often delivered by air drops from airplanes or helicopters. In the event of natural disasters and other emergencies, time may be of the essence to deliver sustenance, medicine, or other critical items to people cut off from life-sustaining supplies. For example, it might be essential to provide water to people cut off from a clean water supply in the event of flooding, an earthquake, and/or a hurricane.

Current disaster and emergency response planning does not adequately address the needs of foreign language communities. The complexities of language and cultural differences pose serious barriers to first responders and emergency providers. Often, disaster relief efforts are conducted by governments, international agencies, or other humanitarian organizations that are not local to the location of the disaster and may speak a different language or be unfamiliar with the culture of the people affected by the disaster. In circumstances where supplies are dropped from aerial vehicles, the recipients may need instructions or other directions that must be sent with the supplies. Therefore, there is a need for a way to quickly program audio content on droppable audio devices and to test the devices.

### SUMMARY OF THE INVENTION

The present invention overcomes the problems and disadvantages associated with current strategies and designs and provides new tools and methods of programming and testing audio messaging devices.

One embodiment of the invention is directed to an audio card programming and testing device. The device comprises a housing, a data storage device contained within the housing, a radio transmission device contained within the housing and adapted to receive data from the data storage device, and a data uploading device contained within the housing and adapted to receive data from the data storage device and upload the data to the audio card.

Preferably, the audio card programming and testing device comprises at least one antenna coupled to the radio transmission device. Preferably, the audio card programming and testing device comprises a data cable adapted to couple the data uploading device to at least one audio card. Preferably, the audio card programming and testing device comprises user control devices.

In a preferred embodiment, the data storage device is adapted to store audio files in at least one of WAV, MPEG, WMA, MP3, AIFF, or DVF formats. The device is preferably adapted to program a plurality of audio cards simultaneously. Preferably, the device is portable. Preferably, the device is ruggedized at least one of water resistant, water proof, and air tight. Preferably, the audio card programming and testing device comprises at least one of a microphone and a speaker. Preferably, the radio transmission device broadcasts at below 10 watts. In a preferred embodiment, the device is adapted to transmit a tests message from the radio transmission device and receive a confirmation message.

Another embodiment of the invention is directed to an audio card programming and testing system. The system comprises a plurality of audio cards, a device adapted to program the plurality of audio cards simultaneously and to test the plurality of audio cards and a printed circuit board (PCB) multiplexor adapted to couple the device to the plurality of audio cards. The device is comprised of a housing, a data storage device contained within the housing, a radio transmission device contained within the housing and adapted to receive data from the data storage device, and a data uploading device contained within the housing and adapted to receive data from the data storage device and upload the data to the audio cards.

In the preferred embodiment, the device broadcasts a radio transmission to be received by each audio cards. Preferably, the radio transmission device is tunable to a preset wavelength of the plurality of audio cards. Preferably, the radio transmission device broadcasts at below 10 watts. The system preferably further comprises at least one antenna coupled to the radio transmission device. The system preferably further comprises a data cable adapted to couple the data uploading device to the PCB multiplexor.

In a preferred embodiment, the device further comprises user controls. Preferably, the data storage device is adapted to store audio files in at least one of WAV, MPEG, WMA, MP3, AIFF, or DVF formats. Preferably, the device is portable. In a preferred embodiment, the device is ruggedized at least one of water resistant, water proof, and air tight. Preferably, the device further comprises at least one of a microphone and a speaker. Preferably, the device is adapted to transmit a tests message from the radio transmission device to each audio card and receive a confirmation message from each audio card.

Other embodiments and advantages of the invention are set forth in part in the description, which follows, and in part, may be obvious from this description, or may be learned from the practice of the invention.

### DESCRIPTION OF THE DRAWINGS

FIG. 1 depicts an embodiment of the programming and testing device with an audio card.

FIG. 2 depicts an embodiment of an audio transmission device.

FIG. 3 depicts an embodiment of a PCB multiplexor connected to a plurality of audio cards.

FIG. 4 depicts an embodiment of a data cable connected to the PCB multiplexor.

FIG. 5 depicts an embodiment of the data cable connected to the audio transmission device.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

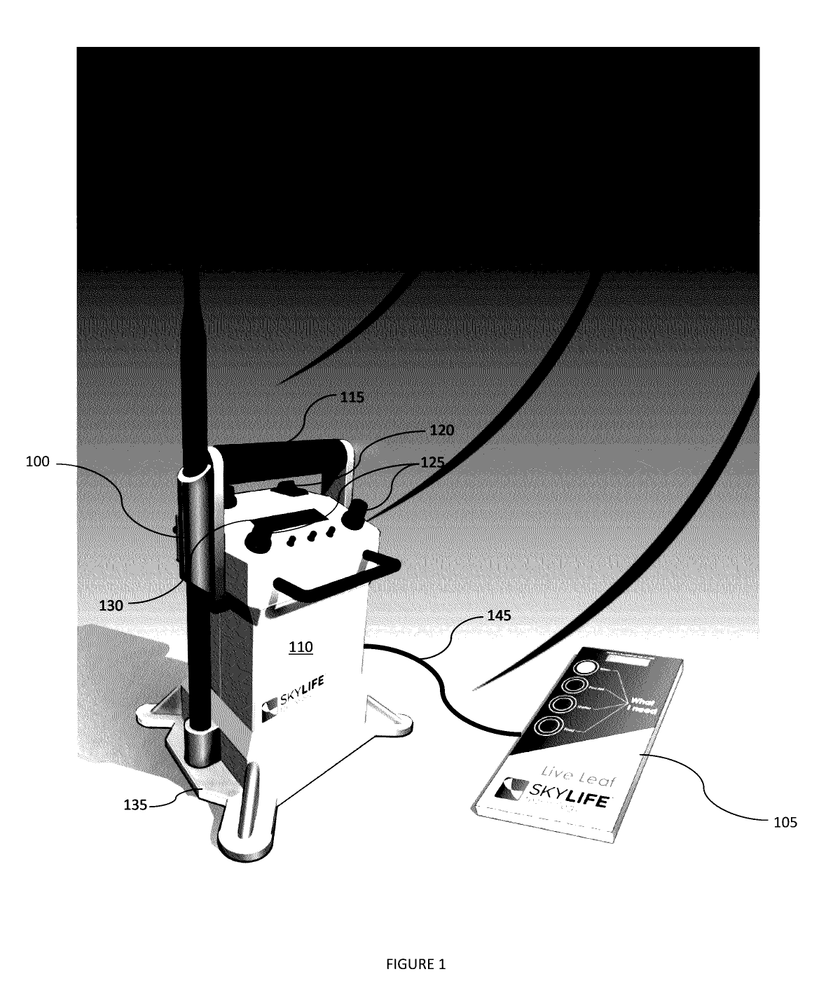

FIG. 1 depicts an embodiment of the programming and testing device 100 with an audio card 105. Audio card 105 is preferably adapted to record and play back an audio message and receive and play radio transmissions. Audio card 105 preferably contains memory, one or more speakers, and a radio receiver or transceiver. The radio receiver or transceiver may be tunable or preset (e.g. during manufacturing or by a deployer of audio card 105) to receive radio transmissions at a certain wavelength. The audio card 105 may additionally contain a microphone to capture audio, a screen for displaying video, one or more buttons to control the audio card, one or more lights or other indicators, and/or printed wording, pictures, or other graphics. Preferably, audio card 105 is adapted to be dropped from an aerial vehicle or is attached to or placed within a droppable device (for example, the packs disclosed in U.S. Pat. No. 8,794,573, which is hereby incorporated by reference in its entirety).

Programming and testing device 100 is preferably a portable system housed as a single unit in housing 100. Housing 100 is preferably made of plastic, however other materials may be used. For example, housing 100 may be made of metal, nylon, fiberglass, fiber reinforced plastic, rubber, ceramics, other naturally occurring or manmade materials, and combinations thereof. Programming and testing device 100 is preferably adapted to be carried by a single person (e.g. via handle 110). Preferably, programming and testing device 100 is less than 100 lbs, preferably less than 50 lbs, preferably less than 25 lbs, more preferably less than 10 lbs, and more preferably less than 5 lbs. Preferably, programming and testing device 100 is water resistant, water proof, and/or air tight. Preferably, programming and testing device 100 is ruggedized for field use. For example, programming and testing device 100 may be shock-resistant, wear-resistant, or vibration-resistant.

Programming and testing device 100 preferably has a plurality of switches and knobs (or other controls) 120 and 125 to control programming and testing device 100. In some embodiments, programming and testing device 100 may have touch screen controls. Programming and testing device 100 may additionally have a display 130 adapted to display information about programming and testing device 100. Programming and testing device 100 preferably has a base 135 to stabilize and support programming and testing device 100 during use. Programming and testing device 100 preferably has at least one antenna 140 adapted to transmit and/or receive radio waves. Antenna 140 is preferably a fixed antenna, however antenna 140 can be collapsible and/or removable. Programming and testing device 100 preferably has at least one data cable 145 adapted to transfer data to audio card 105. Data cable 145 may be a USB cable, a firewire cable, an Ethernet cable, an HDMI cable, a DVI cable, a coaxial cable, an optical fiber cable, a serial cable, an SCSI cable, a DIN cable, or another type of cable. Data cable 145 is preferably a retractable cable, however data cable 145 can be fixed and/or removable. However, programming and testing device 100 may be capable of programming the audio cards 105 wirelessly. Programming and testing device 100 preferably has a power cable for connecting to a power outlet. However, programming and testing device 100 can be powered by batteries (rechargeable or disposable), natural sources (e.g. sunlight, wind, or water), manually (e.g. with a hand crank), have another power source, or combinations thereof. Programming and testing device 100 may additionally have one or more input ports, one or more speakers, and one or more microphones.

The internal components of programming and testing device 100 preferably include at least a data storage device, an audio transmission device, and a radio transmitter. The data storage device is preferably a non-volatile computer storage medium capable of storing digital audio files. For example, the data storage device can be a flash memory device, a ROM device, a RAM device magnetic tape, or an optical disc. Alternatively, data storage device may be an analogue storage device. Preferably, the data storage device is adapted to store digital audio files in one or more formats. For example, the formats may include WAV, MPEG, WMA, MP3, AIFF, DVF, or another format. Data storage device may be loaded via a port in programming and testing device 100, wirelessly, a microphone, and/or another method. Preferably, a user can upload and erase files as desired.

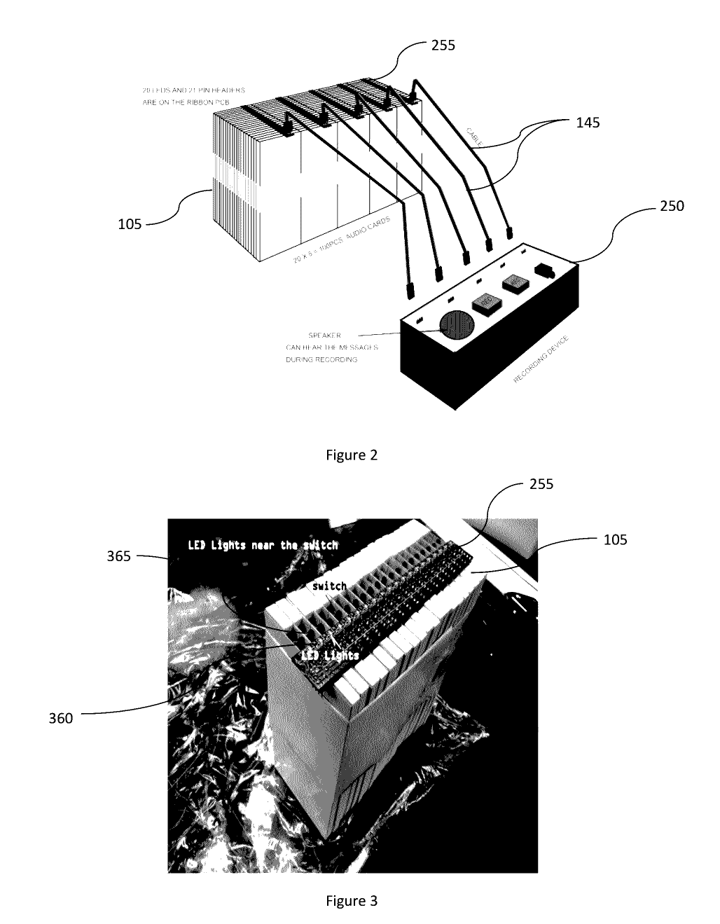

FIG. 2 depicts an embodiment of a data uploading or an audio transmission device 250. While in FIG. 2, the audio transmission device 250 is a standalone device, in the preferred embodiment, audio transmission device 250 is contained within housing 110 of programming and testing device 100. Preferably, audio transmission device 250 is capable of programming up to 10, up to 50, up to 100, up to 200, or more audio cards 105 simultaneously. While five data cables 145 are shown in FIG. 2 for programming audio cards 105, in the preferred embodiment all of the audio cards 105 can be programmed with a single data cable 145. Audio cards 105 may be delivered pre-packaged in cartons of 200 cards each. Each carton preferably contains two layers of audio cards 105. The one hundred cards in each layer may be bundled into five groups of twenty cards each. The cards are preferably oriented with a switch and female pin socket facing up. One or more printed circuit board (PCB) multiplexor 255 preferably allows allow the connection and programming of audio cards 105 simultaneously.

The audio transmission device 250 preferably accepts an audio input from the data storage device. The audio transmission device 250 preferably modulates the input signal and gates the signal to each card connected to the PCB multiplexor 255. The audio transmission device 250 may be connected to a speaker and volume control of programming and testing device 100 to allow a user to hear the message as it is being sent to audio cards 105.

In a preferred embodiment, the steps for programming the audio cards 105 are as follows:

Step 1: Connect the PCB multiplexor 255 to a plug located on each audio card 105. FIG. 3 depicts a proper orientation of the PCB multiplexor 255 when connected to the audio cards 105. LED lights 360 of the PCB multiplexor 255 are preferably aligned with switches 365 of the audio cards 105.

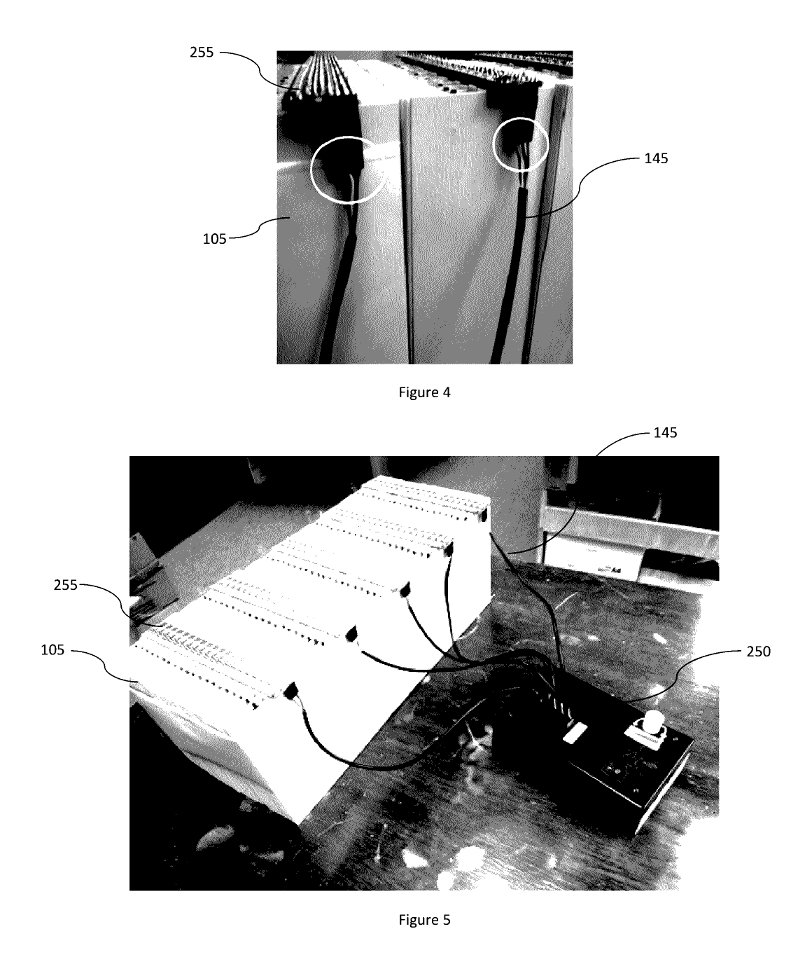

Step 2: Connect the data cable 145 to the PCB multiplexor 255. FIG. 4 depicts a proper orientation of the data cable 145 when connected to the PCB multiplexor 255.

Step 3: Connect the other end of the data cable 145 to the audio transmission device 250. FIG. 5 depicts a proper orientation of the data cable 145 when connected to the audio transmission device 250.

Step 4: Transmit the audio message to the plurality of audio cards 105. Preferably, the transmission is an analog transmission and there is no digital compression, therefore, for example, a 90-second audio file will take 90 seconds to transfer to the cards. However, in some embodiments, the transmission is a digital transmission.

Step 5: Disconnect the data cable 145 from the audio transmission device 250 and the PCB multiplexor 255 and disconnect the PCB multiplexor 255 from the audio cards 105.

Preferably, the programming and testing device 100 also contains a radio transmitter or transceiver for testing the radio receiver of the audio cards 105. Preferably, the radio transmitter transmits a low (e.g. less than 20 watt, less than 15 watt, or less than 10 watt) FM broadcast (although it can may also transmit an AM broadcast). The transmitter can transmit either analogue or digital broadcasts. Preferably, the radio transmitter is tunable to a specific wavelength associated with the audio cards 105. Preferably, the transmitter receives audio files from the data storage device for broadcasting. Additionally, the transmitter may be able to broadcast live audio via a microphone in the programming and testing device 100. Preferably, the audio cards 105 are tested to ensure that they are able to receive the broadcast from the programming and testing device 100. The programming and testing device 100 may also be able to receive messages from the audio cards 105. For example, the audio cards 105 may send a response message upon receiving the test message from the programming and testing device 100. Preferably, the programming and testing device 100 is able to receive the response message and indicate that the message was receive and that the audio card 105 is functioning properly.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising” includes the terms “consisting of” and “consisting essentially of,” and the terms comprising, including, and containing are not intended to be limiting.

1. An audio card programming and testing device, comprising:
a housing;
a data storage device contained within the housing;
a radio transmission device contained within the housing and adapted to receive data from the data storage device; and
a data uploading device contained within the housing and adapted to receive data from the data storage device and upload the data to the audio card.

2. The audio card programming and testing device of claim 1, further comprising at least one antenna coupled to the radio transmission device.

3. The audio card programming and testing device of claim 1, further comprising a data cable adapted to couple the data uploading device to at least one audio card.

4. The audio card programming and testing device of claim 1, further comprising user control devices.

5. The audio card programming and testing device of claim 1, wherein the data storage device is adapted to store audio files in at least one of WAV, MPEG, WMA, MP3, AIFF, or DVF formats.

6. The audio card programming and testing device of claim 1, wherein the device is adapted to program a plurality of audio cards simultaneously.

7. The audio card programming and testing device of claim 1, wherein the device is portable.

8. The audio card programming and testing device of claim 1, wherein the device is ruggedized at least one of water resistant, water proof, and air tight.

9. The audio card programming and testing device of claim 1, further comprising at least one of a microphone and a speaker.

10. The audio card programming and testing device of claim 1, wherein the radio transmission device broadcasts at below 10 watts.

11. The audio card programming and testing device of claim 1, wherein the device is adapted to transmit a tests message from the radio transmission device and receive a confirmation message.

12. An audio card programming and testing system, comprising:
a plurality of audio cards;
a device adapted to program the plurality of audio cards simultaneously and to test the plurality of audio cards, wherein the device is comprised of:
a housing;
a data storage device contained within the housing;
a radio transmission device contained within the housing and adapted to receive data from the data storage device; and
a data uploading device contained within the housing and adapted to receive data from the data storage device and upload the data to the audio cards; and
a printed circuit board (PCB) multiplexor adapted to couple the device to the plurality of audio cards.

13. The audio card programming and testing system of claim 12, wherein the device broadcasts a radio transmission to be received by each audio cards.

14. The audio card programming and testing system of claim 13, wherein the radio transmission device is tunable to a preset wavelength of the plurality of audio cards.

15. The audio card programming and testing system of claim 13, wherein the radio transmission device broadcasts at below 10 watts.

16. The audio card programming and testing system of claim 12, further comprising at least one antenna coupled to the radio transmission device.

17. The audio card programming and testing system of claim 12, further comprising a data cable adapted to couple the data uploading device to the PCB multiplexor.

18. The audio card programming and testing system of claim 12, wherein the device further comprises user controls.

19. The audio card programming and testing system of claim 12, wherein the data storage device is adapted to store audio files in at least one of WAV, MPEG, WMA, MP3, AIFF, or DVF formats.

20. The audio card programming and testing system of claim 12, wherein the device is portable.

21. The audio card programming and testing system of claim 12, wherein the device is ruggedized at least one of water resistant, water proof, and air tight.

22. The audio card programming and testing system of claim 12, wherein the device further comprises at least one of a microphone and a speaker.

23. The audio card programming and testing system of claim 12, wherein the device is adapted to transmit a tests message from the radio transmission device to each audio card and receive a confirmation message from each audio card.
